(19) United States
(12) Patent Application Publication
(10) Pub. No.: US 2020/0267999 A1
(43) Pub. Date: Aug. 27, 2020

(54) Bakery Food Product

(71) Applicant: Lo-Dough Limited, Rochdale (GB)

(72) Inventors: Ben Holden, Tarporley (GB); Robert Wales, Uppermill (GB)

(73) Assignee: Lo-Dough Limited, Rochdale (GB)

(21) Appl. No.: 16/308,171

(22) PCT Filed: Jun. 7, 2017
(86) PCT No.: PCT/GB2017/051650

§ 371 Date: Mar. 14, 2019

(30) Foreign Application Priority Data
Jun. 8, 2016 (GB) 1609989.7
Feb. 6, 2017 (GB) 1701907.6

(51) Int. Cl. A21D 13/068; A21D 13/043; A21D 2/18; A21D 15/04; A21D 2/26; A21D 2/36; A23L 29/238; A23L 29/244; A23L 29/262; A23L 33/21

(52) U.S. Cl. CPC A21D 13/068; A21D 13/043; A21D 2/188; A21D 15/04; A21D 2/262; A23L 33/21; A21D 2/183; A23L 29/238; A23L 29/244; A23L 29/262; A21D 2/36

(57) ABSTRACT

The present invention relates to a bakery food product produced from a mucilaginous hydrocolloid and a mannan-based hydrocolloid. The bakery food product is low fat and has a long shelf life, and a higher water resistance than traditional dough based foods. Also provided is a a method for making the bakery food product, and a liquid mixture for making a bakery product. Also provided are dehydrated food products produced from a mucilaginous hydrocolloid and a mannan-based hydrocolloid.

The present invention relates to a bakery food product, a method for making a bakery food product, and a liquid mixture for making a bakery product. The invention also relates to a dehydrated food product; and to a meal item comprising a bakery food product or a dehydrated food product of the invention.

### BACKGROUND

Excess calorie intake has been linked to obesity and various diseases including diabetes. Additionally, obesity is often seen as unattractive amongst many Eastern and Western populations. For these reasons there is a need for food products which have a reduced calorie content. Reduction in calorie content may be achieved by reducing the fat content or reducing the carbohydrate content of a food product. More recently, since certain fats have been recognised as being important to a healthy lifestyle, low carbohydrate diets have become popular in order to reduce weight gain, lose excess weight and to maintain a healthy weight.

Carbohydrate based foods are an important component of the Western diet. Such food products are generally made from plain or wholemeal flour, yeast and water. Fat and sugar may also be added. Due to the carbohydrate content, such foods have a high calorie density, often reaching and even exceeding 500 kcal per 100 grams. Convenience foods such as pizzas and bread based products play an important role in a Western diet, but are generally carbohydrate based and high in calories.

The present invention aims to overcome or ameliorate the problems associated with the prior art.

### BRIEF SUMMARY OF THE DISCLOSURE

In a first aspect, the present invention provides a bakery food product comprising a mucilaginous hydrocolloid, a mannan-based hydrocolloid, egg protein, insoluble fibre and water.

In a suitable embodiment, the present invention provides a low fat bakery food product for human consumption comprising a mucilaginous hydrocolloid, a mannan-based hydrocolloid, egg protein, insoluble fibre and water, wherein the food product comprises less than 3% by weigh of fat.

In a second aspect, the present invention provides a method of making a bakery food product, the method comprising the steps of:
i) mixing a mucilaginous hydrocolloid, a mannan-based hydrocolloid, insoluble fibre, and water to provide a first mixture;
ii) combining the first mixture with egg white to provide a liquid mixture;
iii) optionally, applying the liquid mixture onto a baking sheet;
iv) heating the liquid mixture to remove water and provide a substantially dehydrated food product; and
v) re-hydrating the dehydrated food product of iv); and
vi) optionally, forming the food product into shapes.

In a suitable embodiment, the present invention provides a method of making a low fat bakery food product for human consumption, wherein the food product comprises less than 3% by weight of fat, the method comprising the steps of:
i) mixing a mucilaginous hydrocolloid, a mannan-based hydrocolloid, insoluble fibre, and water to provide a first mixture;
ii) combining the first mixture with egg white to provide a liquid mixture;
iii) optionally, applying the liquid mixture onto a baking sheet;
iv) heating the liquid mixture to remove water and provide a substantially dehydrated food product; and
v) re-hydrating the dehydrated food product of iv); and
vi) optionally, forming the food product into shapes.

In an embodiment, step i) and step ii) of the method of the invention may be combined into a single step. In such an embodiment a mucilaginous hydrocolloid, a mannan-based hydrocolloid, insoluble fibre, water and egg white are mixed together to provide a liquid mixture.

In both the embodiments of the second aspect relating to separate steps i) and ii) or a combined steps i) and ii) the egg white may be provided in the form of raw albumen from an edible egg, or in the form of egg white powder. Egg white powder may be reconstituted prior to its combination with other ingredients, or may be reconstituted during process with liquid (e.g. water) provide in a mixture.

In a third aspect, the present invention provides a liquid mixture comprising a mucilaginous hydrocolloid, a mannan-based hydrocolloid, egg white, insoluble fibre, and water.

In a suitable embodiment, the present invention provides a low fat liquid mixture comprising a mucilaginous hydrocolloid, a mannan-based hydrocolloid, egg white, insoluble fibre, and water; wherein the liquid mixture comprises between 0.1% and 10% by weight of a mucilaginous hydrocolloid, 0.1% and 10% by weight of a mannan-based hydrocolloid, between 5% and 50% by weight of egg white, between 1% and 15% by weight of insoluble fibre, and between 50% and 90% of water, and optionally between 0.1% and 10% by weight of a texture enhancer; and wherein the liquid mixture comprises less than 3% by weight of fat.

In a fourth aspect, the present invention provides a dehydrated food product comprising a mucilaginous hydrocolloid, a mannan-based hydrocolloid, egg protein and insoluble fibre.

In a suitable embodiment, the present invention provides a low fat dehydrated food product for human consumption comprising a mucilaginous hydrocolloid, a mannan-based hydrocolloid, egg protein and insoluble fibre, and wherein the dehydrated food product comprises less than 3% by weight of fat.

A dehydrated food product may be produced according to a method of steps i) to iv) of the second aspect, optionally including step vi). A method of producing a dehydrated food product of the fourth aspect excludes the rehydration step v) of the method of the second aspect of the invention.

In a fifth aspect, the present invention provides a meal item comprising:
a bakery food product of the first aspect of the invention, or a dehydrated food product of the fourth aspect of the invention; and
a topping, filling, dressing, sauce, and/or spread.

In a suitable embodiment, the present invention provides a meal item comprising:
a low fat bakery food product for human consumption comprising a mucilaginous hydrocolloid, a mannan-based hydrocolloid, egg protein, insoluble fibre and water, wherein the bakery food product comprises less than 3% by weigh of fat, or
a low fat dehydrated food product for human consumption comprising a mucilaginous hydrocolloid, a mannan-based hydrocolloid, egg protein and insoluble fibre, and wherein the dehydrated food product comprises less than 3% by weight of fat; and
a topping, filling, dressing, sauce, and/or spread.

In a sixth aspect, the present invention provides a long shelf life food product comprising a mucilaginous hydrocolloid, a mannan-based hydrocolloid, egg protein, insoluble fibre, and optionally water.

In a suitable embodiment, the present invention provides a low fat, long shelf life food product for human consumption, comprising a mucilaginous hydrocolloid, a mannan-based hydrocolloid, egg protein, insoluble fibre, and optionally water, wherein the long shelf life food product comprises less than 3% by weigh of fat.

### DETAILED DESCRIPTION

The present invention is based on the surprising finding that a composition comprising a mucilaginous hydrocolloid, a mannan-based hydrocolloid, egg white, insoluble fibre, and water may be used to form a liquid mixture, which can be used as the basis for manufacturing a variety of food products which are traditionally made from dough. The inventors have surprisingly found that food products of the first and fourth aspect of the invention may have a higher water resistance than traditional dough based foods high in carbohydrates such as breads, rolls, pizza bases, wraps, crackers, etc. This unique property allows the food products of the invention to maintain their structural integrity for longer periods of time in the presence of moist fillings, dressing, sauces, etc. This is particularly relevant for the convenience or ready-made food market.

Additionally, the inventors have surprisingly found that the food product of the invention may be able to withstand a sterilisation process (for example sterilisation by retort), allowing the product to have a long shelf life. This property is especially important in the context of a bakery food product, which traditionally has a short shelf life often leading to significant amounts of bakery food products being wasted. The inventors have found that the food products of the invention comprising the ingredients and/or made according to the methods discussed elsewhere in this specification, are able to withstand a sterilisation process.

The present invention is based on a unique method of making a bakery food product. The method involves preparing a liquid mixture comprising a mucilaginous hydrocolloid, a mannan-based hydrocolloid, egg white, insoluble fibre, water, and optionally a texture enhancer, heating the liquid mixture to remove water and provide a substantially dehydrated food product, and rehydrating the dehydrated food product to provide a bakery food product.

The term “food product” as used herein, encompasses both, a bakery food product of the first aspect of the invention, and a dehydrated food product of the fourth aspect of the invention. The term “food product” refers to foods which are substantially gluten free. The food products of the invention may be used as a substitute for food products which are conventionally made from a dough or a batter. Thus, the food products of the invention may be used as a substitute for food products which conventionally comprise gluten. The food products of the invention may be used as a substitute for food products which conventionally contain flour and/or grains. Thus, food products which traditionally contain flour or grains may be replaced by a food product of the present invention and are included within the scope of the present invention. Such food products include bakery items and/or dried carbohydrate based food products.

The term “bakery food product” refers to a food product which is a substitute for a food product conventionally made from a dough or a batter, and which comprises water. Therefore, a bakery food item of the present invention may be similar, or substantially the same, in terms of texture and/or taste to a conventional food product derived from dough or batter. Such conventional food products may include without limitation, pizza bases, wraps, flatbreads, tortillas, breads, cakes, pastries, pancakes, rolls, waffles and biscuits. Therefore, a bakery food product of the invention may be referred to as a “bread-like” product or a “bread substitute”. A bakery food product of the invention may be selected from the group consisting of: pizza bases, wraps, flatbreads, tortillas, breads, cakes, pastries, pancakes, rolls, waffles and biscuits. Herein, and due to the method of manufacture, a bakery food product may also be referred to as a “rehydrated food product”.

The term “dehydrated food product” refers to a food product which is a substitute for a food product conventionally made from a grain or flour which substantially do not comprise water. Such a food product may be a substitute for a dried food product conventionally made from a dough or batter. Therefore, a dehydrated food product of the present invention may be similar, or substantially the same, in terms of texture and/or taste to a conventional dried food product made from a grain or flour, or derived from dough or batter. Such conventional food products may include, without limitation, a cracker, a portion of crisps, a portion of noodles, a portion of dried pasta, a portion of dried cereal, a cereal bar, a portion of dried porridge, or a portion of dried muesli. Therefore, a dehydrated food product of the invention may include a cracker, crisp, biscuit, noodle, pasta, cereal, cereal bar, porridge, or muesli, or a portion of any such item.

A bakery food product of the first aspect of the invention, a dehydrated food product of the fourth aspect of the invention, and a long shelf life food product of the sixth aspect of the invention are suitable for consumption by humans (adults and/or children). A food product of the invention intended for human consumption may not include food products intended for animal consumption, for example non-human animals such as farm animals (such as cows, sheep, goats, etc) or domestic animals (such as cats and dogs). A food product of the invention for human consumption may therefore exclude food items such as animal dry meals, biscuits and treats.

A bakery food product of the first aspect of the invention comprises a mucilaginous hydrocolloid, a mannan-based hydrocolloid, egg protein, insoluble fibre, water, and optionally a texture enhancer. A dehydrated food product of the fourth aspect of the invention comprises a mucilaginous hydrocolloid, a mannan-based hydrocolloid, egg protein, insoluble fibre, and optionally a texture enhancer.

A food product of the invention is a low carbohydrate product. The term “carbohydrate” refers to a carbohydrate which is digestible and/or absorbable by humans. Accordingly, carbohydrates derived from fibres which may not be digested or absorbed by humans are not encompassed by the term “carbohydrate” in this specification. The “carbohydrate” content of the food product may be substantially derived from a mucilaginous hydrocolloid. By “low carbohydrate” it is meant that the food product has a carbohydrate content of 15, 14, 13, 12, 11, 10, 9, 8, 7, 6, 5, 4, 3, 2, or 1 gram(s) or less per 100 grams of food product. Suitably, the food product has a carbohydrate content of 1.0, 0.75, 0.5, or 0.3 grams or less per 100 grams of food product. Suitably, when a food product of the invention is a bakery food product according to the first aspect of the invention, it may have a carbohydrate content of 0.3 grams or less per 100 grams. Suitably, when a food product of the invention is a dehydrated food product according to the fourth aspect of the invention, it may have a carbohydrate content of 1 gram or less per 100 grams.

The food product of the invention may be a low calorie product. A calorie as used herein is an approximate amount of energy needed to raise the temperature of one gram of water by one degree Celsius at a pressure of one atmosphere. A kilocalorie (kcal) is 1000 calories. By “low calorie” it is meant that the food product may have a calorie content of less than 300, 250, 150, 100, 90, 80, 70, 60, or 50 kcal per 100 grams. Suitably, when the food product is a bakery food product according to the first aspect of the invention, it may have a calorie content of less than 80 kcal per 100 grams. Suitably, when the food product is a dehydrated food product according to the fourth aspect of the invention, it may have a calorie content of less than 250 kcal per 100 grams.

The food product of the invention may be a low fat product. By “low fat” it is meant that the food product has a fat content of less than 3, 2.8, 2.6, 2.4, 2.2, 2, 1.8, 1.6, 1.4, 1.2, 1, 0.8, 0.6, 0.4, or 0.2 grams of fat per 100 grams. In other terms, it can be said the food product of the invention comprises less than 3%, 2.8%, 2.6%, 2.4%, 2.2%, 2%, 1.8%, 1.6%, 1.4%, 1.2%, 1%, 0.8%, 0.6%, 0.4%, or 0.2% by weight of fat. Suitably, the food product of the invention may be substantially fat free. By “substantially fat free” it is meant that the fat content of the food product of the invention is less than 0.1 grams of fat per 100 grams, i.e. it comprises less than 0.1% by weight of fat. The term “fat” refers to triglyceride molecules naturally found within the ingredients described herein, from which the food products of the first, third, fourth or sixth aspect of the invention are made from.

The food product of the invention may be a high fibre product. By “high fibre” it is meant that the food product has a fibre content of at least 3, 3.2, 3.4, 3.6, 3.8, 4, 4.2, 4.4, 4.6, 4.8, 5, 5.2, 5.4, 5.6, 5.8, 6 or more grams of fibre per 100 grams of fibre per 100 grams. It will be appreciated the fibre content may be derived not only from the insoluble fibre, but also from the mucilaginous hydrocolloid (such as psyllium), the mannan-based hydrocolloid (for example konjac), and/or a texture enhancer (for example hydroxypropylmethylcellulose), if such a texture enhancer is present.

The term “mucilaginous hydrocolloid” refers to a hydrocolloid substance comprising polymers of one or more monosaccharides, which when exposed to a fluid (such as water) forms a slimy mass. By way of example, a mucilaginous hydrocolloid may be obtained from a plant, in particular from a seed of a plant, in particular from a seed husk. Suitable mucilaginous hydrocolloids may include psyllium, linseed (also known as flaxseed), and chia seed.

The term “psyllium” as used herein, refers to the seed from plants of the Plantago genus. Suitable seeds may be obtained from various Plantago species, including without limitation P. laceolate, P. rugelii and P. major. Other suitable species will be known to the person skilled in the art. Reference to psyllium includes intact whole seeds and/or milled seeds, and intact or milled seed husks. Milled seeds or husks may of any suitable degree of coarseness, for example a rough or a fine powder.

The term “mannan-based hydrocolloid” refers to a hydrocolloid substance comprising a mannan, in particular a glucomannan and/or a galactomannan. A mannan-based hydrocolloid may suitably be high in mannan content, for example comprise at least 30% by weight of mannan. An example of a hydrocolloid substance high in glucomannan is konjac.

Examples of hydrocolloids high in galactomannan include locust bean gum, guar gum, carob tree, carob bean gum, senna gum, tara gum and fenugreek gum. Other suitable mannan-based hydrocolloids which may be used in the present invention will be known to the skilled person.

The term “konjac” as used herein, refers to a plant of the genus Amorphophallus. Suitably “konjac” may refer to the tubers of the Amorphophallus plant. Preferably, the tubers may be ground. Suitably ground tubers may be in the form of konjac flour.

The term “egg protein” as used herein refers to the albumin protein and other proteins found within the egg white. It will be appreciated that the egg white, which is comprised of approximately 90% of water, is converted to egg protein during the process of heating, which removes the water content from the liquid mixture.

The term “water” as used herein refers to pure water as well as a water based liquid. A water based liquid may comprise at least 70%, 75%, 80%, 85%, 90%, 95%, or at least 99% water. A water based liquid may comprise food enhancers. Examples of suitable food enhancers are described herein.

The term “insoluble fibre” as used herein, refers to fibre which is essentially insoluble in water. In the context of the present invention, suitable insoluble fibre may be selected from the group consisting of: wheat fibre, oat fibre, cellulose, hemicellulose and lignin, or a combination thereof. Preferably, the insoluble fibre is wheat fibre.

The term “texture enhancer” as used herein, refers to a substance which has the effect of changing the texture of a food product, for example by increasing or decreasing any aspect of texture including for example the elasticity, density, shape formation and retention, softness, binding, stretchiness, stability of a food, which would have a different texture in the absence of the enhancer. A texture enhancer may suitably serve to increase the similarity between a food product of the invention and a conventional food product (e.g. a food product derived from dough or batter, or made from a grain or flour, for which the food product of the invention may be a substitute of). A texture enhancer is typically an additive rather than a food ingredient. Suitable texture enhancers for use in the present invention may include those which in the presence of a liquid, such as water, increases softness, elasticity and/or stretchiness of the food product compared to the softness, elasticity and/or stretchiness of the food product in the absence of the texture enhancer. A texture enhancer may provide a more bread-like texture. Suitable texture enhancers for use in the present invention will be known to persons skilled in the art, and include for example those which are commonly used as gluten substitutes. By way of example, a texture enhancer may be selected from the group consisting of a cellulose derivative, a gum (such as carrageenan and xanthan gum) and or a starch (such as arrowroot, corn starch and potato starch).

The term “cellulose derivative” refers to a substance obtained by a chemical modification of cellulose. In the context of the present invention, a particularly useful cellulose derivative is hydroxypropylmethylcellulose (HPMC). Other types of cellulose derivatives will be known to the skilled person. Merely by way of example, these may include arboxymethylcellulose, methylcellulose, and hydroxypropyl cellulose.

The term “egg white” as used herein refers to raw albumen. In one embodiment, the raw albumen may be directly obtained from an edible egg, such as an egg from a hen, turkey, duck, goose or pheasant. Egg white may be obtained from egg white powder reconstituted in a suitable liquid, such as water. The use of egg white powder reconstituted in water may be preferred due to its ability to make a bakery food product with an improved (e.g. brighter, or increased whiteness) appearance than may be achieved when using egg white obtained directly from an edible egg in the invention. This may enable a bakery food product produced by the present invention to more closely resemble the colour of white bread.

In the context of the present invention, egg white powder may be reconstituted in a liquid at a ratio of between 5 and 30% of egg white powder: between 95% and 70% liquid, respectively; more suitably between 10 and 20% of egg white powder: between 90% and 80% of liquid, respectively; most suitably approximately 12.5% of egg white powder: approximately 87.5% of water. Therefore, in such an embodiment, 100 grams of egg white is obtained from 12.5 grams of egg white powder and 87.5 grams of water.

In the present specification, when reference is made to the percentage of egg white in the liquid mixture, this is based on an egg white obtained directly from an egg, or an egg white obtained from egg white power reconstituted in water at a concentration of 12.5% of egg white powder and 87.5% of water. However, the skilled person will appreciate that if these concentrations are altered, the amount of water used to make liquid mixture may require adjustment accordingly to yield a product having the proportions defined herein. For example, if the egg white comprises more than 12.5% egg white powder, the amount of water to make the liquid mixture may be proportionally increased. By the same token, if the egg white comprises less than 12.5% egg white powder, the amount of water to make the liquid mixture may be proportionally decreased.

It will be appreciated that when reference is made to the percentage of water in a food product of the first or fourth aspect of the invention, or in a liquid mixture of the third aspect of the invention, the percentage does not include the water which may be derived from egg white, and/or used to reconstitute egg white powder.

A bakery food product of the first aspect of the invention may comprise at least 0.5%, 1%, 1.5%, 2%, 2.5%, 3%, 3.5%, 4%, 4.5%, 5%, 6%, 7%, 8%, 9%, 10%, 11%, 12%, 13%, 14%, 15%, or at least 20% by weight of a mucilaginous hydrocolloid. Preferably, the bakery food product may comprise at least 1% by weight of a mucilaginous hydrocolloid, more suitably between 1.5% and 5% of a mucilaginous hydrocolloid. Where a texture enhancer is present, the bakery food product may preferably comprise at least 1% by weight of a mucilaginous hydrocolloid, suitably between 1% and 5% by weight of a mucilaginous hydrocolloid.

A bakery food product of the first aspect of the invention may comprise at least 0.5%, 1%, 1.5%, 2%, 2.5%, 3%, 3.5%, 4%, 4.5%, 5%, 6%, 7%, 8%, 9%, 10%, 11%, 12%, 13%, 14%, 15%, or at least 20% by weight of a mannan-based hydrocolloid. Preferably, the bakery food product may comprise at least 1% by weight of a mannan-based hydrocolloid, more suitably between 1.5% and 5% of a mannan-based hydrocolloid. Where a texture enhancer is present, the bakery food product may preferably comprise at least 1% by weight of a mannan-based hydrocolloid, suitably between 1% and 5% by weight of a mannan-based hydrocolloid.

A bakery food product of the first aspect of the invention may comprise at least 1%, 2%, 3%, 4%, 5%, 6%, 7%, 8%, 9%, 10%, 11%, 12%, 13%, 14%, 15%, 16%, 17%, 18%, 19%, 20%, 25%, or at least 30% by weight of egg protein. Suitably, the bakery food product may comprise at least 6% by weight of egg protein, preferably between 6% and 10% by weight of egg protein. Where a texture enhancer is present, the bakery food product preferably may comprise at least 5% by weight of egg protein, suitably between 5% and 10% by weight of egg protein. In another embodiment, the bakery food product may comprise at least 12% by weight of egg protein, preferably between 12% and 20% by weight of egg protein. Where a texture enhancer is present, the bakery food product preferably may comprise at least 10% by weight of egg protein, suitably between 10% and 20% by weight of egg protein.

A bakery food product of the first aspect of the invention may comprise at least 5%, 6%, 7% 8%, 9%, 10%, 11%, 12%, 13%, 14%, 15%, 20%, 21%, 22%, 23%, 24%, 25%, 30%, 35%, or at least 40% by weight of insoluble fibre. Suitably, the bakery food product may comprise at least 15% by weight of insoluble fibre, more suitably between 15% and 20% by weight, of insoluble fibre. Where a texture enhancer is present, the bakery food product may preferably comprise at least 12% by weight of insoluble fibre, suitably between 12% and 20% by weight of insoluble fibre. In another embodiment, the bakery food product may comprise at least 20% by weight of insoluble fibre, more suitably between 20% and 25% by weight, of insoluble fibre. Where a texture enhancer is present, the bakery food product may preferably comprise at least 15% by weight of insoluble fibre, suitably between 15% and 25% by weight of insoluble fibre.

A bakery food product of the first aspect of the invention may comprise at least 15%, 20%, 25%, 30%, 35%, 40%, 45%, 50%, 52%, 55%, 60%, 61%, 62%, 63%, 64%, 65%, 66%, 67%, 68%, 69%, 70%, 75%, or at least 80% by weight of water. Preferably, the bakery food product of the invention may comprise at least 60% by weight of water, suitably between 60% and 75% by weight of water. More preferably, the bakery food product of the invention may comprise at least 50% by weight of water, suitably between 50% and 60% by weight of water.

A bakery food product of the first aspect of the invention may comprise at least 0.5%, 1%, 1.5%, 2%, 2.5%, 3%, 3.5%, 4%, 4.5%, 5%, 6%, 7%, 8%, 9%, 10%, 11%, 12%, 13%, 14%, or at least 15% by weight of a texture enhancer. Preferably, the bakery food product may comprise at least 5% by weight of a texture enhancer, suitably between 5% and 10% by weight of a texture enhancer.

A bakery food product of the invention may comprise at least 70%, 75%, 80%, 85%, 90%, 91%, 92%, 93%, 94%, 95%, 96%, 97%, 98%, or at least 99% by weight, of a combination of a mucilaginous hydrocolloid, mannan-based hydrocolloid, insoluble fibre, egg protein, water and optionally a texture enhancer. Suitably, the food product may comprise at least 90%, preferably between 90% and 95% by weight of a combination of a mucilaginous hydrocolloid, mannan-based hydrocolloid, insoluble fibre, egg protein, water and optionally a texture enhancer.

Suitably, a bakery food product of the invention may comprise between 0.5% and 20% by weight of a mucilaginous hydrocolloid, between 0.5% and 20% by weight of a mannan-based hydrocolloid, between 5% and 40% by weight of insoluble fibre, between 1 and 20% by weight of egg protein, and between 30% and 80% of water, and optionally between 0.5% and 15% by weight of a texture enhancer. More suitably, a bakery food product of the invention may comprise between 0.5% and 20% by weight of a mucilaginous hydrocolloid, between 0.5% and 20% by weight of a mannan-based hydrocolloid, between 5% and 40% by weight of insoluble fibre, between 1 and 30% by weight of egg protein, and between 30% and 80% of water, and optionally between 0.5% and 15% by weight of a texture enhancer.

Preferably, a bakery food product of the invention may comprise between 1% and 5% by weight of a mucilaginous hydrocolloid, between 1% and 5% by weight of a mannan-based hydrocolloid, between 12% and 20% by weight of insoluble fibre, between 5% and 10% by weight of egg protein, between 60% and 70% of water, and optionally between 5% and 10% by weight of a texture enhancer. Preferably, the mucilaginous hydrocolloid is psyllium. Preferably, the mannan-based hydrocolloid is konjac. Preferably the insoluble fibre is wheat fibre. Preferably, the texture enhancer is HPMC.

More preferably, a bakery food product of the invention may comprise between 1% and 5% by weight of a mucilaginous hydrocolloid, between 1% and 5% by weight of a mannan-based hydrocolloid, between 20% and 25% by weight of insoluble fibre, between 10% and 20% by weight of egg protein, between 50% and 60% of water, and optionally between 5% and 10% by weight of a texture enhancer. Preferably, the mucilaginous hydrocolloid is psyllium. Preferably, the mannan-based hydrocolloid is konjac. Preferably the insoluble fibre is wheat fibre. Preferably, the texture enhancer is HPMC.

In a suitable embodiment, a bakery food product of the invention may comprise approximately 2.5% by weight of a mucilaginous hydrocolloid, approximately 2.5% by weight of a mannan-based hydrocolloid, approximately 20% by weight of insoluble fibre, approximately 6% by weight of egg protein, approximately 62% by weight of water, and optionally approximately 7% by weight of a texture enhancer. Preferably, the mucilaginous hydrocolloid is psyllium. Preferably the mannan-based hydrocolloid is konjac. Preferably the insoluble fibre is wheat fibre. Preferably, the texture enhancer is HPMC.

In a most suitable embodiment, a bakery food product of the invention may comprise approximately 2% by weight of a mucilaginous hydrocolloid, approximately 2% by weight of a mannan-based hydrocolloid, approximately 20% by weight of insoluble fibre, approximately 16% by weight of egg protein, approximately 52% by weight of water, and optionally approximately 6% by weight of a texture enhancer. Preferably, the mucilaginous hydrocolloid is psyllium. Preferably the mannan-based hydrocolloid is konjac. Preferably the insoluble fibre is wheat fibre. Preferably, the texture enhancer is HPMC.

In a third aspect, the present invention provides a liquid mixture which may be used to produce a food product of the first or fourth aspect of the invention. When the liquid mixture is heated to remove the water content, the dehydrated food product of the fourth aspect may be obtained. When the dehydrated food product is subsequently rehydrated, the bakery food product of the first aspect may be obtained.

A liquid mixture according to the third aspect of the invention may comprise at least 0.1%, 0.2%, 0.3%, 0.35%, 0.5%, 1%, 2%, 3%, 4%, 5%, 6%, 7%, 8%, 9%, at least 10% by weight, of a mucilaginous hydrocolloid. Preferably, the liquid mixture may comprise at least 0.3% by weight of a mucilaginous hydrocolloid, suitably between 0.3% and 1% by weight of a mucilaginous hydrocolloid. Preferably, the liquid mixture may comprise at least 0.5% by weight of a mucilaginous hydrocolloid, suitably between 0.5% and 1% by weight of a mucilaginous hydrocolloid. Preferably the mucilaginous hydrocolloid is psyllium.

A liquid mixture according to the third aspect of the invention may comprise at least 0.1%, 0.2%, 0.3%, 0.35%, 0.5%, 1%, 2%, 3%, 4%, 5%, 6%, 7%, 8%, 9%, at least 10% by weight, of a mannan-based hydrocolloid. Preferably, the liquid mixture may comprise at least 0.3% by weight of a mannan-based hydrocolloid, suitably between 0.3% and 1% by weight of a mannan-based hydrocolloid. Preferably, the liquid mixture may comprise at least 0.5% by weight of a mannan-based hydrocolloid, suitably between 0.5% and 1% by weight of a mannan-based hydrocolloid. Preferably the mannan-based hydrocolloid is konjac.

The liquid mixture according to the third aspect of the invention may comprise at least 5%, 6%, 7%, 8%, 9%, 10%, 11%, 12%, 13%, 14%, 15%, 16%, 17%, 18%, 19%, 20%, 21%, 22%, 23%, 24%, 25%, 30%, 40%, or at least 50% by weight, of egg white. Preferably, the liquid mixture may comprise at least 15% by weight, of egg white, suitably the liquid mixture may comprise between 15% and 20% by weight, of egg white. Preferably, the liquid mixture may comprise at least 20% by weight, of egg white, suitably the liquid mixture may comprise between 20% and 25% by weight, of egg white.

The liquid mixture according to the third aspect of the invention may comprise at least 1% 2%, 2.5%, 3%, 3.5%, 4%, 4.5%, 5%, 6%, 7%, 8%, 9%, 10%, 11%, 12%, 13%, 14%, or at least 15% by weight of insoluble fibre. Preferably, the liquid mixture may comprise at least 3% by weight, of insoluble fibre, suitably between 3% and 8% by weight of insoluble fibre. Preferably, the liquid mixture may comprise at least 4% by weight, of insoluble fibre, suitably between 4% and 10% by weight of insoluble fibre. Preferably the insoluble fibre is wheat fibre.

The liquid mixture of the third aspect of the invention may comprise at least 50%, 55%, 60%, 70%, 75%, 80%, 85%, or at least 90% by weight, of water. Preferably, the liquid mixture of the third aspect may comprise at least 70% of water, suitably between 75% and 80% of water, preferably between 70% and 75% of water.

The liquid mixture according to the third aspect of the invention may optionally comprise at least 0.1%, 0.2%, 0.3%, 0.4%, 0.5%, 1%, 1.5%, 2%, 2.5%, 3%, 3.5%, 4%, 4.5%, 5%, 6%, 7%, 8%, 9%, or at least 10% by weight, of a texture enhancer. Preferably, the liquid mixture comprises at least 1% by weight of a texture enhancer, suitably between 1 and 2% by weight of a texture enhancer. Preferably, the texture enhancer is HPMC.

In an embodiment, the liquid mixture may comprise between 0.1% and 10% by weight of a mucilaginous hydrocolloid, 0.1% and 10% by weight of a mannan-based hydrocolloid, between 5% and 50% by weight of egg white, between 1% and 15% by weight of insoluble fibre, and between 50% and 90% of water, and optionally between 0.1% and 10% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

Preferably, the liquid mixture may comprise between 0.3% and 1% by weight of a mucilaginous hydrocolloid, 0.3% and 1% by weight of a mannan-based hydrocolloid, between 20% and 25% by weight of egg white, between 3% and 10% by weight of insoluble fibre, and between 70% and 75% of water, and optionally between 1% and 2% by weight of a texture enhancer. Preferably the mucilaginous hydrocolloid is psyllium. Preferably the mannan-based hydrocolloid is konjac. Preferably the insoluble fibre is wheat fibre.

Preferably the texture enhancer is HPMC.

Preferably, the liquid mixture may comprise between 0.5% and 1% by weight of a mucilaginous hydrocolloid, 0.5% and 1% by weight of a mannan-based hydrocolloid, between 15% and 20% by weight of egg white, between 4% and 10% by weight of insoluble fibre, and between 75% and 80% of water, and optionally between 1% and 2% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

In a most suitable embodiment, the liquid mixture may comprise approximately 0.5% by weight of a mucilaginous hydrocolloid, approximately 0.5% by weight of a mannan-based hydrocolloid, approximately 16% by weight of egg white, approximately 5% by weight of insoluble fibre, and approximately 75% of water, and optionally approximately 1.5% by weight of a texture enhancer. Preferably the mucilaginous hydrocolloid is psyllium.

Preferably the mannan-based hydrocolloid is konjac. Preferably the insoluble fibre is wheat fibre. Preferably the texture enhancer is HPMC.

In a most suitable embodiment, the liquid mixture may comprise approximately 0.35% by weight of a mucilaginous hydrocolloid, approximately 0.35% by weight of a mannan-based hydrocolloid, approximately 23% by weight of egg white, approximately 4% by weight of insoluble fibre, and approximately 70% of water, and optionally approximately 1% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

In an embodiment, the liquid mixture may comprise a mucilaginous hydrocolloid, a mannan-based hydrocolloid, egg white, insoluble fibre, and water, and optionally water in proportions suitable to provide a bakery food product comprising 0.5%-20% of a mucilaginous hydrocolloid, 0.5%-20% a mannan-based hydrocolloid, 1%-30% of egg protein, 5%-40% of insoluble fibre, and 30%-80% of water, and optionally 1%-15% of a texture enhancer.

In an embodiment, the amount of a mucilaginous hydrocolloid, a mannan-based hydrocolloid, egg white, insoluble fibre and water, and optionally a texture enhancer in the liquid mixture may be adjusted within the afore-mentioned ranges so as to provide a bakery food product where in total these ingredients account for at least 90% of the bakery food product.

In an embodiment, the amount of a mucilaginous hydrocolloid, a mannan-based hydrocolloid, egg white, insoluble fibre, and water, and optionally a texture enhancer may be adjusted within the afore-mentioned ranges so as to provide a dehydrated food product of the invention, where the mucilaginous hydrocolloid, the mannan-based hydrocolloid, egg protein, insoluble fibre, and optionally texture enhancer account for at least 90% of the dehydrated food product.

In an embodiment, the amount of the mucilaginous hydrocolloid, the mannan-based hydrocolloid, egg white, insoluble fibre, and water, and optionally texture enhancer may be adjusted within the afore-mentioned ranges so that in total these ingredients account for approximately 90-100% of the liquid mixture.

As touched upon elsewhere in the specification, the liquid mixture of the third aspect of the invention may be used to produce a dehydrated food product according to fourth aspect of the invention. Such a dehydrated food product comprises a mucilaginous hydrocolloid, a mannan-based hydrocolloid, egg protein, insoluble fibre, and optionally a texture enhancer. In one embodiment, the dehydrated food product of the fourth aspect of the invention may comprise 1%-25% of a mucilaginous hydrocolloid, 1%-25% a mannan-based hydrocolloid, 5%-50% of egg protein, 30%-90% of insoluble fibre, and optionally 0.1%-10% of water, and optionally 5%-40% of a texture enhancer.

A dehydrated food product of the fourth aspect of the invention may comprise at least 1%, 1.5%, 2%, 2.5%, 3%, 3.5%, 4%, 4.5%, 5%, 6%, 7%, 8%, 9%, 10%, 11%, 12%, 13%, 14%, 15%, 20%, or at least 25% by weight of a mucilaginous hydrocolloid. Preferably, the dehydrated food product may comprise at least 3.5% by weight, of a mucilaginous hydrocolloid, suitably between 3.5% and 10% by weight, of a mucilaginous hydrocolloid. Preferably, the dehydrated food product may comprise at least 5% by weight, of a mucilaginous hydrocolloid, suitably between 5% and 10% by weight, of a mucilaginous hydrocolloid. Preferably the mucilaginous hydrocolloid is psyllium.

A dehydrated food product of the fourth aspect of the invention may comprise at least 1%, 1.5%, 2%, 2.5%, 3%, 3.5%, 4%, 4.5%, 5%, 6%, 7%, 8%, 9%, 10%, 11%, 12%, 13%, 14%, 15%, 20%, or at least 25% by weight of a mannan-based hydrocolloid. Preferably, the dehydrated food product may comprise at least 3.5% by weight, of a mannan-based hydrocolloid, suitably between 3.5% and 10% by weight, of a mannan-based hydrocolloid. Preferably, the dehydrated food product may comprise at least 5% by weight, of a mannan-based hydrocolloid, suitably between 5% and 10% by weight, of a mannan-based hydrocolloid. Preferably the mannan-based hydrocolloid is konjac.

A dehydrated food product of the fourth aspect of the invention may comprise at least 5%, 6%, 7%, 8%, 9%, 10%, 11%, 12%, 13%, 14%, 15%, 16%, 17%, 18%, 19%, 20%, 21%, 22%, 23%, 24%, 25%, 30%, 32%, 35%, 40%, 45%, or at least 50% by weight, of egg protein. Preferably, the dehydrated food may comprise at least 15% by weight, of egg protein, suitably between 15% and 25% by weight, of egg protein. Preferably, the dehydrated food may comprise at least 25% by weight, of egg protein, suitably between 25% and 35% by weight, of egg protein.

A dehydrated food product of the fourth aspect of the invention may comprise at least 30%, 35%, 40%, 45%, 50%, 55%, 60%, 61%, 62%, 63%, 64%, 65%, 66%, 67%, 68%, 69%, 70%, 75% or at least 80% by weight, of insoluble fibre. Preferably, the dehydrated food may comprise at least 40% by weight, of insoluble fibre, suitably between 40% and 50% by weight, of insoluble fibre. Preferably, the dehydrated food may comprise at least 50% by weight, of insoluble fibre, suitably between 50% and 70% by weight, of insoluble fibre. Preferably the insoluble fibre is wheat fibre.

A dehydrated food product of the fourth aspect of the invention may comprise at least 5%, 10%, 11%, 12%, 13%, 14%, 15%, 16%, 17%, 18%, 19%, 20%, 25%, 30%, 35%, or at least 40% by weight, of a texture enhancer. Preferably, the dehydrated food may comprise at least 10% by weight, of a texture enhancer, suitably between 10% and 15% by weight, of a texture enhancer. Preferably, the dehydrated food may comprise at least 15% by weight, of a texture enhancer, suitably between 15% and 25% by weight, of a texture enhancer. Preferably the texture enhancer is HPMC.

A dehydrated food product of the fourth aspect of the invention may comprise 15%, 14%, 13%, 12%, 11%, 10%, 9%, 8%, 7%, 6%, 5%, 4%, 3%, 2%, 1%, 0.5% or less, or 0.1% or less by weight of water. Preferably, the dehydrated food product may comprise 5% or less by weight of water.

In an embodiment, the dehydrated food product may comprise between 1% and 25% by weight of a mucilaginous hydrocolloid, 1% and 25% by weight of a mannan-based hydrocolloid, between 5% and 50% by weight of egg protein, between 30% and 80% by weight of insoluble fibre, and optionally between 5% and 40% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

Preferably, the dehydrated food product may comprise between 3.5% and 10% by weight of a mucilaginous hydrocolloid, 3.5% and 10% by weight of a mannan-based hydrocolloid, between 25% and 35% by weight of egg protein, between 40% and 50% by weight of insoluble fibre, and optionally between 10% and 15% by weight of a texture enhancer.

Preferably the mucilaginous hydrocolloid is psyllium. Preferably the mannan-based hydrocolloid is konjac. Preferably the insoluble fibre is wheat fibre. Preferably the texture enhancer is HPMC.

Preferably, the dehydrated food product may comprise between 5% and 10% by weight of a mucilaginous hydrocolloid, 5% and 10% by weight of a mannan-based hydrocolloid, between 15% and 25% by weight of egg protein, between 50% and 70% by weight of insoluble fibre, and optionally between 15% and 25% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

In a most suitable embodiment, the dehydrated food product may comprise approximately 9% by weight of a mucilaginous hydrocolloid, approximately 9% by weight of a mannan-based hydrocolloid, approximately 22% by weight of egg protein, approximately 63% by weight of insoluble fibre, and optionally approximately 18% by weight of a texture enhancer.

Preferably the mucilaginous hydrocolloid is psyllium. Preferably the mannan-based hydrocolloid is konjac. Preferably the insoluble fibre is wheat fibre. Preferably the texture enhancer is HPMC.

In a suitable embodiment, the dehydrated food product may comprise approximately 3.5% by weight of a mucilaginous hydrocolloid, approximately 3.5% by weight of a mannan-based hydrocolloid, approximately 32% by weight of egg protein, approximately 40% by weight of insoluble fibre, and optionally approximately 12% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

A dehydrated food product according to the fourth aspect of the invention may be rehydrated to produce a bakery food product according to the first aspect of the invention. Thus, it will be appreciated that the final percent weight of a mucilaginous hydrocolloid, mannan-based hydrocolloid, insoluble fibre, egg protein and, if present, a texture enhancer in a bakery food product of the first aspect of the invention may ultimately depend on the amount of water removed from the liquid mixture during heating and the extent to which the dehydrated food product is rehydrated.

Merely by way of example, the dehydrated food product may comprise 99% by weight of a mucilaginous hydrocolloid, mannan-based hydrocolloid, insoluble fibre, egg protein and, if present, a texture enhancer. When the dehydrated food product is rehydrated so as to comprise 65% by weight of water, the percent weight of a mucilaginous hydrocolloid, mannan-based hydrocolloid, insoluble fibre, egg protein and, if present, texture enhancer will decrease to approximately 35%.

A bakery food product of the first aspect, a liquid mixture of third aspect, and/or the dehydrated food product of the fourth aspect of the invention may comprise a food enhancer. Suitably, the food products and/or liquid mixture of the invention may comprise less than 10%, 9%, 8%, 7%, 6%, 5%, 4%, 3%, 2%, or less than 1% by weight, of a food enhancer.

Suitable food enhancers may enhance the taste, mouthfeel, appearance and/or longevity of the food product. In one embodiment, an enhancer may enhance one or more of these.

For example, food enhancers that enhance the taste of the food product may be selected from the group consisting of: food acids (for example citric acid), natural flavour (for example salt, pepper, and garlic powder), artificial flavours (for example monosodium glutamate, potassium bromate, potassium sorbate, and vanillan), condiments (for example salt and paper) and sweeteners (for example stevia, agave syrup, aspartame, high-fructose corn syrup, saccharin, sucralose and sugar alcohol, or any combination thereof. Other suitable food enhancers that enhance the taste of the food products will be known by the skilled person.

Food enhancers that enhance the mouthfeel of the food products, may be selected from the group consisting: emulsifiers (for example oils and fat), humectants (for example sorbitol, glycerol, and propylene glycol), or a combination thereof. Other food enhancers that enhance the mouthfeel of the food products will be apparent to the skilled person.

Food enhancers that enhance the appearance of the food product may be selected from the group consisting of: food colouring (for example artificial and natural food dyes), colour retention agents (for example ascorbic acid) and glazing agents (for example propylene glycol, eggin, dimethylpolysiloxane, beeswax, candelilla wax and carnauba wax), or any combination thereof. Other food enhancers that enhance the appearance of the food products will be apparent to the skilled person.

Food enhancers that enhance the longevity of the food product of the invention may be selected from the group consisting of: stabilizers (for example alginic acid, gelatin and lecithin), preservatives (for example propionic acid and sodium propionate) and antioxidants (for example ascorbic acid, butylated hydroxytoluene, and butylated hydroxyanisole), or any combination thereof. Other food enhancers that enhance the longevity of the food products will also be apparent to the skilled person.

Preferably, the bakery food product of the first aspect of the invention may comprise less than 2%, or less than 1% by weight of a food enhancer. Preferably, the food enhancer is a taste enhancer, preferably the taste enhancer is salt.

Preferably, the dehydrated food product of the fourth aspect of the invention may comprise less than 5% by weight of a food enhancer. Preferably, the food enhancer is a taste enhancer, preferably the taste enhancer is salt.

It will be appreciated that the food product of the first and fourth aspect, and the liquid mixture of the third aspect may comprise other suitable ingredients. When the food product and/or the liquid mixture of the invention comprises other such ingredients, the skilled person will be able to adjust the above mentioned proportions (for example based on the ranges of suitable proportions disclosed elsewhere within this specification) to obtain a food product or liquid mixture of the invention.

A bakery food product of the first aspect and a dehydrated food product of the fourth aspect of the invention may be of any shape. By way of example, a food product of the invention (such as a pizza base, wrap or a cracker) may be circular, square or rectangular in shape. Suitably, the bakery food product of the invention, and in particular a pizza base or a wrap, may be circular in shape.

A bakery food product of the first aspect and a dehydrated food product of the fourth aspect of the invention may be of any size. For example, in the context of a pizza base or a wrap circular in shape, the circle may have a diameter of 1, 2, 4, 5, 6, 7, 8, 9, 10, 11 or more inches. In the context of a cracker rectangular in shape, the rectangle may have a length of 1, 2, 3, 4, 5 or more inches.

In the second aspect, the invention provides a method of making a bakery food product, the method comprising the steps of:
i) mixing a mucilaginous hydrocolloid, a mannan-based hydrocolloid, insoluble fibre, and water to provide a first mixture;
ii) combining the first mixture with egg white to provide a liquid mixture;
iii) optionally, applying the liquid mixture onto a baking sheet;
iv) heating the liquid mixture to remove water and provide a substantially dehydrated food product; and
v) optionally re-hydrating the dehydrated food product of iv)
vi) optionally forming the food product into shapes.

The method may be a method for making a bakery food product of the first aspect or a method of making a dehydrated food product of the fourth aspect. Also provided by the present invention is a method of making a liquid mixture of step ii) wherein the method comprises i) mixing a mucilaginous hydrocolloid, a mannan-based hydrocolloid, insoluble fibre, water and optionally a texture enhancer to provide a first mixture; and ii) combining the first mixture with egg white to provide a liquid mixture. The egg white may be whisked prior to being combined with the liquid mixture.

The term “whisked” or “whisking” as used herein, refers to any form of mixing which serves to aerate the egg white. Suitably whisking may result in the formation of a foam from the egg whites. Suitably, the egg white, before being combined with the first mixture, may be whisked until stiff peaks are formed. The term “stiff peaks” refers to the texture of the egg white foam and can be identified by the formation of peaks in the foam which are maintained despite removal of the whisking implement or movement/upturning of the container in which whisking is performed. In an embodiment, the egg white may be whisked prior to or after the mixing of step i) or simultaneously with the mixing of step i). Whisking of the egg white may continue for any suitable period of time until a foam, and preferably stiff peaks are formed. This may be between 10 and 120 seconds. Preferably, whisking maybe for approximately 60 seconds. The timings used may vary in a commercial scale kitchen.

In a suitable embodiment, steps i) and ii) of the second aspect of the invention may be combined into a single step. In such an embodiment the mucilaginous hydrocolloid, the mannan-based hydrocolloid, insoluble fibre, water and egg white are all mixed together to provide the liquid mixture.

In both the embodiments of the second aspect relating to separate steps i) and ii) or a combined steps i) and ii) the egg white may be provided in the form of raw albumen from an edible egg, or in the form of egg white powder. Egg white powder may be reconstituted prior to its combination with other ingredients, or may be reconstituted during process with liquid (e.g. water) provide in a mixture. Therefore, in an embodiment where steps i) and ii) are separate, egg white powder may be reconstituted prior to step ii). Alternatively, the egg white powder may be reconstituted during step ii), for example using liquid (e.g. water) present in the first mixture, or liquid (e.g. water) which may be added during step ii). Therefore, step ii) may comprise combining the first mixture with reconstituted egg white powder to provide a liquid mixture; or combining the first mixture with egg white powder to provide a liquid mixture; or combining the first mixture with egg white powder and a suitable liquid (e.g. water) to provide a liquid mixture.

Accordingly, in one aspect, the invention provides a method of making a bakery food product, the method comprising the steps of:

i) mixing a mucilaginous hydrocolloid, a mannan-based hydrocolloid, insoluble fibre, egg white and water to provide a liquid mixture;

ii) optionally, applying the liquid mixture onto a baking sheet;

iii) heating the liquid mixture to remove water and provide a substantially dehydrated food product; and

iv) optionally re-hydrating the dehydrated food product of iii)
v) optionally forming the food product into shapes.

It will be appreciated that when a mucilaginous hydrocolloid, a mannan-based hydrocolloid, insoluble fibre, egg white and water are mixed to provide a first mixture, the egg white may be obtained from egg white powder which has been reconstituted prior to step i), or which is reconstituted in a suitable liquid (e.g. water) during the step of mixing.

It will also be appreciated that when the bakery food product of the first aspect of the invention and the liquid mixture of the third aspect of the invention comprise a texture enhancer, these may be obtained according to the method of the second aspect of the invention, where step i) involves mixing a mucilaginous hydrocolloid, mannan-based hydrocolloid, insoluble fibre, water and the texture enhancer. Where step i) and step ii) of the method of the invention are combined into a single step, a mucilaginous hydrocolloid, mannan-based hydrocolloid, insoluble fibre, egg white and water, and optionally the texture enhancer may be mixed together.

The product of step v) or step vi) may undergo an optional step of searing. The term “searing” refers to a brief exposure of the rehydrated food product to heat, in order to provide a chargrilled or baked appearance and/or texture. The temperature may be between 140° C.-300° C. Searing may last from a few seconds, up to several minutes. Merely by way of example, searing may be performed by placing the food product on a hotplate, pan, grill, or a barbeque.

Searing may be performed in the presence of a fat. Suitable examples of searing fat include plant and/or animal based fats. An example of a plant based fat is olive oil, margarine, sunflower oil and coconut oil. An example of an animal fat is butter. It will be appreciated that any type of edible fat may be used.

As mentioned elsewhere in this specification, the food product of the present invention may be a low fat or substantially fat free food product. It will be appreciated that when the food product of the invention is seared, it is coated with a layer of searing fat but the content of fat in the food product itself remains low or substantially fat free.

The term “mixing” as used herein refers to combining a mucilaginous hydrocolloid, a manna based hydrocolloid, insoluble fibre, water and egg white (if present) and optionally cellulose derivative and other ingredients until the ingredients are substantially uniformly distributed.

Mixing may be under any suitable conditions. In an embodiment, high shear or high dispersal conditions may be used, for example at a rate of 3000 RPM or more, 4000 RPM or more, or 5000 RPM or more. Mixing may continue for any suitable time period to achieve uniform distribution. A suitable time period may for example be between 1 and 30 seconds. More suitably, mixing may be between 15 and 30 seconds. In an embodiment, mixing continues until the first mixture has reached a viscosity of approximately 40,000 centipoise (cP).

In step ii) of the second aspect, the first mixture and egg white are combined to form a liquid mixture. In an embodiment, combining may be performed by blending, stirring or folding. Blending, stirring or folding may continue until the liquid mixture reaches a viscosity of approximately 25,000 cP. In an embodiment where step i) and step ii) are combined into a single step, blending, stirring or folding of a mucilaginous hydrocolloid, mannan-based hydrocolloid, insoluble fibre, egg white, water, and optionally the texture enhancer may continue until the liquid mixture reaches a viscosity of approximately 25,000 cP.

The liquid mixture may be aerated. Aerating the liquid mixture reduces its specific gravity.

Suitably, aerating may reduce the specific gravity of the liquid mixture from between 0.7-0.9 to 0.4-0.6. Although there are various methods by which the liquid mixture may be aerated, merely by way of example, the liquid mixture may be aerated by mixing. A Shufflemixer is an example of a mixer suitable for aerating the liquid mixture.

The combining of the first mixture with the egg white may last any suitable period of time, and may in some embodiments as mentioned above, be a continuous process. In a batch process, combining may continue for a minimum period of time to achieve uniform distribution of the first mixture and egg white foam whilst avoiding air loss or loss of texture of the liquid mixture obtained. In a batch process, a suitable time period for combination may be between 10 and 60 seconds.

In an embodiment where step i) and step ii) of the second aspect of the invention are carried out in a single step, the mucilaginous hydrocolloid, mannan-based hydrocolloid, insoluble fibre, water and egg white are mixed together. In such an embodiment, mixing may last any suitable period of time, and may in some embodiments as mentioned above, be a continuous process. In a batch process, mixing may continue for a minimum period of time to achieve uniform distribution of the mucilaginous hydrocolloid, mannan-based hydrocolloid, insoluble fibre, water and egg white in the liquid mixture. In a batch process, a suitable time period for mixing may be between 10 and 600 seconds.

In a suitable embodiment, the liquid mixture may be allowed to rest prior to commencement of step iii) of the method of the second aspect. Resting may occur at any suitable temperature, for example room temperature or refrigerated at a temperature between 2° C. and 20° C. Resting may last up to 1 hour, up to 2 hours, up to 3 hours, up to 4 hours, up to 5 hours, up to 10 hours. In an embodiment, resting may last up to 3 hours.

Applying the liquid mixture to a baking tray may be performed in any suitable way, typically depending upon the desired form of the final food product. For example, liquid mixture may be spread onto a baking tray, in a uniform or non-uniform manner, or may be applied in discrete portions to a baking tray. The term “spreading” as used herein, refers to placing a thin layer of the liquid mixture onto a baking tray. The thickness of the spread liquid mixture may depend upon the desired food product. For example, where the desired food product is a crisp, the layer of liquid mixture may be approximately between 1 mm and 5 mm thick. Where the desired food product is a pizza base, the layer of liquid mixture may be approximately between 5 mm and 20 mm thick. The portion size of liquid mixture may depend on the desired food product. Merely by way of example, for a biscuit, the portion may be approximately between 20 and 40 ml, while for a pizza base the portion may be between 150 and 500 ml.

The term “baking tray” as used herein, refers to any container or surface on which the food product may be heated. Merely by way of example, a baking tray may be: a baking tin, a baking sheet, or a baking mould. The surface area of the “baking tray” may be lined with a suitable non-stick coating such as Polytetrafluoroethylene (PTFE).

In step iv), the liquid mixture is heated to remove water therefrom, to provide a substantially dehydrated food product. Heating may be in the form of baking or dehydration, or indeed any other suitable method. The term “dehydrating” as used herein, refers to gradual removal of water content from the liquid mixture, typically at a low temperature without cooking the ingredients of the liquid mixture. Dehydrating may comprise the removal of moist air, and the replacement with fresh air. Dehydrating may last between 1 and 12 hours, more suitably between 4 and 8, most suitably 2 hours. Dehydrating may occur at a temperature between 80° C. and 200° C., preferably between 90° C. and 150° C., more preferably between 135° C. and 140° C. Alternatively, removal of water from the liquid mixture may be achieved by baking, during which the liquid mixture is heated over a shorter period of time at a temperature of between 150° C. and 200° C.

In a suitable embodiment, heating of the liquid mixture may be achieved through the use of a baking oven. Alternatively, heating of the liquid mixture may be achieved through the use of a dehydrator. Other methods suitable for heating the liquid mixture will be known to the skilled person.

In a suitable embodiment, heating may last until 80%, 85%, 90%, 95% or more of water, has been removed from the liquid mixture. In a suitable embodiment, drying of the liquid may continue until the dehydrated food product of step iv) comprising 15%, 14%, 13%, 12%, 11%, 10%, 9%, 8%, 7%, 6%, 5%, 4%, 3%, 2% or 1% or less of water is formed.

In step v) of the method of the second aspect of the invention, the dehydrated product may be rehydrated to provide a bakery food product. The step of rehydrating the dehydrated food may increase the weight of the bakery food product as compared to the dehydrated food product. Suitably, the weight of the bakery food product as compared to the dehydrated food product may increase by between 50% and 150%. More suitably, the weight of the bakery food product as compared to the dehydrated food product may increase by approximately 100% upon rehydrating. The dehydrated food product may be rehydrated using water.

Suitably, the water may be at a temperature of between 2° C. and 70° C., more suitably at a temperature of between 5° C. and 20° C. In a suitable embodiment, the dehydrated food product may be rehydrated in any suitable way, for example by spraying, brushing, coating, soaking and/or dipping in water. Alternatively or additionally, the dehydrated food product may be rehydrated by incubation in a moist environment.

Flavourings, topping, and enhancers may be added at any suitable step of the process, including for example at one or more of the following stages: in formation of the first mixture; during egg whisking, if present; during formation of the liquid mixture; after resting of the liquid mixture; immediately prior to heating; after heating; prior to rehydration; after rehydration; or prior to packaging. By “during” is meant immediately prior to, in the process of, or immediately after the referenced step.

The method of the invention may further comprise packaging of the food product. The food product may be a dehydrated food product, or rehydrated food product. The term “packaging” as used herein, refers to placing the food product in a sealable container.

Merely by way of example, a sealable container may be a box (for example a plastic or cardboard box), a bag (for example a plastic bag, paper bag or foil bag) or a pouch (for example a plastic pouch or retort pouch). Other suitable means for packaging will be known to the skilled person.

In an embodiment, the method of the invention may further comprise a step of sterilising the food product. Suitably, the food product may be sterilised in the packaging. Sterilisation of the food product may be obtained by any suitable method which will allow the product to have a long shelf life. By “long shelf life” it is meant that the product will remain fit for consumption, if stored appropriately, for at least 3, 6, 9, 12, 16, 20, 24 months or longer from the sterilisation of the food product. Appropriated storage includes keeping the product in an airtight packaging until the food product is to be consumed.

Various methods of food sterilisation will be known to the skilled person. Suitably, the food product of the invention may be sterilised using methods selected from the group consisting of: retort sterilisation, microwave sterilisation, radio wave sterilisation, pasteurisation, and ultra-heat treatment (UHT). Preferably, the food product of the invention is sterilised by retort sterilisation.

It will be appreciated that when the food product is sterilised in the packaging, the packaging must be able to withstand the conditions of the sterilisation process. Thus, for example, when the food product is sterilised by retort, the packaging must be able to withstand heat and pressure of the retort sterilisation process. Suitably, when the food product is sterilised by retort, it may be packaged in a retort pouch.

In a further aspect, the invention provides a method of making a bakery food product, the method comprising the steps of:
i) mixing a mucilaginous hydrocolloid, a mannan-based hydrocolloid, insoluble fibre, egg white and water to provide a liquid mixture;
ii) optionally, applying the liquid mixture onto a baking sheet;
iii) heating the liquid mixture to remove water and provide a substantially dehydrated food product;
iv) optionally re-hydrating the dehydrated food product of iii)
v) optionally forming the food product into shapes; and
vi) sterilising the food product.

A method comprising the step of sterilising the food product, gives rise to the sixth aspect of the invention which relates to a long shelf life food product comprising a mucilaginous hydrocolloid, a mannan-based hydrocolloid, egg protein, insoluble fibre, and optionally water. It will be appreciated that if the long shelf life food product does not comprise water, it is a dehydrated food product of the fourth aspect of the invention which has been sterilised. By the same token, if the long shelf life food product comprises water, it is a food product of the first aspect of the invention which has been sterilised.

In the context of the fifth aspect the term “meal item” refers to a food which comprises a food product of the first or fourth aspect of the invention, in addition to a topping, filling, dressing, sauce, and/or spread. A suitable topping or filling may be, for example, selected from the group consisting of: dairy (such as cheese), eggs, meat (for example ham), fish, vegetables, fruits, herbs, and spices. A suitable dressing or sauce may be, for example, selected from the group consisting of passata (tomato sauce), ketchup, mayonnaise, mustard, olive oil, balsamic vinegar, caeser dressing, French dressing, honey, maple syrup, agave syrup, and fruit compote. A suitable spread may be selected from the group consisting of: cream cheese, chocolate spread, peanut butter, marmite, butter, and jam.

It will be the appreciated that the percentages mentioned throughout this specification refer to the food products themselves, i.e. the bakery food product of the first aspect, or the dehydrated food product of the fourth aspect of the invention. The percentages do not include any toppings, fillings, dressings, spreads, which may be added to the food products of the invention to provide a meal item.

Merely by way of example, a meal item comprising a bakery food product of the first aspect of the invention may be selected from the group consisting of: a pizza, a wrap sandwich, a quesadilla, a sandwich, a burrito, a chimichanga, and a Mexican lasagne. Other suitable meal items will be known to the skilled person. Merely by way of example, a meal item comprising a dehydrated food product of the fourth aspect of the invention may be tacos or tortilla chips.

The invention is not restricted to the details of any forgoing embodiments. The embodiments of each aspect apply to the other aspects of the invention, mutatis mutandis.

Throughout the description and claims of this specification, the words “comprise” and “contain” and variations of them mean “including but not limited to”, and they are not intended to (and do not) exclude other components. Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular embodiment of the invention are to be understood to be applicable to any other embodiment described herein unless incompatible therewith. All of the features disclosed in this specification (including any accompanying claims and drawings) may be combined in any combination, except combinations where at least some of such features and/or steps are mutually exclusive. The invention extends to any novel one, or any novel combination, of the features disclosed in this specification (including any accompanying claims and drawings).

### EXAMPLES

### Example 1 a Rehydrated Food Product

For a rehydrated food product (such as a pizza base), a liquid mixture of 376 grams was prepared using the following ingredients:
Psyllium—2 grams (accounting for ˜0.5% of the liquid mixture),
Konjac—2 grams (accounting for ˜0.5% of the liquid mixture),
Egg white—50 ml (accounting for ˜13.5% of the liquid mixture)
Wheat fibre—16 grams (accounting for ˜4% of the liquid mixture),
Water—300 grams (accounting for ˜80% of the liquid mixture), and optionally
Hydroxypropyl methylcellulose (HPMC)—˜5 grams (accounting for 1.5% of the liquid mixture), and optionally
Salt—1 grams (accounting for ˜0.5% of the liquid mixture)

Psyllium, konjac, wheat fibre, HPMC, salt and water were mixed under high dispersal conditions until the mixture reached a viscosity of approximately 40,000 cP. Separately, the egg white was whisked until stiff peaks were obtained, upon which the whisked egg white and mixture of water and dry ingredients were combined by blending until a uniform blended mixture with a viscosity of 25,000 cP was obtained.

The blended mix was allowed to rest for 5 minutes at room temperature before it was transferred to a PTFE lined baking tray and dehydrated in an oven at a temperature of 95° C. for 8 hours. The dehydration process removed approximately 95% of the water initially found in the liquid mixture. The dehydrated pizza base was then rehydrated by submerging it in water until it reached a weight of ˜80 grams. Approximately 50 ml of water was used.

Upon rehydration the pizza base was briefly seared (for 1 minutes) on a hotplate with 5 ml of olive oil.

A pizza base made as outlined above weighs approximately 80 grams and has the following nutritional values (per 80 grams):

70 kcal (if the step of searing is not carried out), or 94 kcal (if seared); 0.7 grams of carbohydrates; 23 grams of fibre; 7 grams of protein; and no gluten.

### Example 2 a Rehydrated Food Product

Psyllium—1.5 grams (accounting for ˜0.35% of the liquid mixture),
Konjac—1.5 grams (accounting for ˜0.35% of the liquid mixture),
Egg white powder—12.5 grams (accounting for ˜3% of the liquid mixture)
Water for reconstituting the egg white powder˜87.5 grams (accounting for ˜20.5% of the liquid mixture; together the egg white powder and water form egg white, which accounts for ˜203.5% of the liquid mixture)
Wheat fibre—16 grams (accounting for ˜4% of the liquid mixture),
Water—300 grams (accounting for ˜70% of the liquid mixture), and optionally
Hydroxypropyl methylcellulose (HPMC)—˜5 grams (accounting for 1% of the liquid mixture), and optionally
Salt—1 grams (accounting for ˜0.25% of the liquid mixture)

Psyllium, konjac, wheat fibre, HPMC, egg white, salt and water were mixed under high dispersal conditions until the mixture was in the form of a foamy batter.

The blended mix was aerated before 175 grams of the mix were transferred to a baking tray and dehydrated in an oven at a temperature of approximately 135° C. until approximately 95% of the water initially found in the liquid mixture. The food product was then rehydrated by spraying with water until it reached double its dehydrated weight.

Upon rehydration the food product was packaged in a retort pouch and sterilised in a retort machine. The sterilisation process was carried out at a temperature of approximately 121° C. and a pressure of approximately 1.8 bar. The sterilisation process under these pressure conditions may last for approximately 3 to 5 minutes.

The following numbered paragraphs are not claims but represent aspects and embodiments of the invention.

1. A bakery food product comprising a mucilaginous hydrocolloid, a mannan-based hydrocolloid, egg protein, insoluble fibre and water

2. The bakery food product of paragraph 1, wherein the mucilaginous hydrocolloid is psyllium.

3. The bakery food product of paragraphs 1 to 2, wherein the mannan-based hydrocolloid is konjac.

4. The bakery food product of paragraphs 1 to 3, wherein the insoluble fibre is wheat fibre.

5. The bakery food product of paragraphs 1 to 4, further comprising a texture enhancer.

6. The bakery food product of paragraph 5, wherein the texture enhancer is hydroxypropylmethylcellulose (HPMC).

7. The bakery food product of paragraphs 1 to 6, wherein the food product comprises between 0.5% and 20% by weight of a mucilaginous hydrocolloid, 0.5% and 20% by weight of a mannan-based hydrocolloid, between 1% and 30% by weight of egg protein, between 5% and 40% by weight of insoluble fibre, and between 30% and 80% of water, and optionally between 0.5% and 15% by weight of a texture enhancer.

8. The bakery food product of paragraph 7, wherein the food product comprises between 1% and 5% by weight of a mucilaginous hydrocolloid, 1% and 5% by weight of a mannan-based hydrocolloid, between 12% and 20% by weight of egg protein, between 20% and 25% by weight of insoluble fibre, and between 50% and 60% of water, and optionally between 5% and 10% by weight of a texture enhancer.

9. The bakery food of paragraph 8, wherein the food product comprises approximately 2% by weight of a mucilaginous hydrocolloid, approximately 2% by weight of a mannan-based hydrocolloid, approximately 16% by weight of egg protein, approximately 20% by weight of insoluble fibre, and approximately 52% by weight of water, and optionally approximately 6% by weight of a texture enhancer.

10. The bakery food product of paragraphs 1 to 7, wherein the food product comprises between 0.5% and 20% by weight of psyllium, 0.5% and 20% by weight of konjac, between 1% and 30% by weight of egg protein, between 5% and 40% by weight of wheat fibre, and between 30% and 80% of water, and optionally between 0.5% and 15% by weight of HPMC.

11. The bakery food product of paragraph 10, wherein the food product comprises between 1% and 5% by weight of psyllium, 1% and 5% by weight of konjac, between 12% and 20% by weight of egg protein, between 20% and 25% by weight of wheat fibre, and between 50% and 60% of water, and optionally between 5% and 10% by weight of HPMC.

12. The bakery food product of paragraph 11, wherein the food product comprises approximately 2% by weight of psyllium, approximately 2% by weight of konjac, approximately 16% by weight of egg protein, approximately 20% by weight of wheat fibre, and approximately 52% of water, and optionally approximately 6% by weight of HPMC.

13. The bakery food product according to any preceding claim, wherein the food product is selected from the group consisting of: pizza base, wrap, flatbread, tortilla, bread, cake, pastry, pancake, roll, waffle and biscuit.

14. A method of making a bakery food product, the method comprising the steps of:
i) mixing a mucilaginous hydrocolloid, a mannan-based hydrocolloid, insoluble fibre and water, to provide a first mixture;
ii) combining the first mixture with egg white to provide a liquid mixture;
iii) optionally, applying the liquid mixture onto a baking sheet;
iv) heating the liquid mixture to remove water and provide a substantially dehydrated food product; and
v) re-hydrating the dehydrated food product of iv)
vi) optionally forming the food product into shapes.

15. The method of paragraph 14, wherein the egg white is obtained from egg white powder reconstituted in water.

16. The method of paragraphs 14 to 15, wherein step i) and step ii) are combined into a single step.

17. The method of paragraphs 14 to 16, further comprising the step of whisking egg white prior to combining with the first mixture.

18. The method of paragraphs 14 to 17, further comprising the step of resting the liquid mixture prior to heating.

19. The method of paragraphs 14 to 18 wherein heating is performed at a temperature between 80° C. and 200° C., preferably between 90° C. and 150° C.

20. The method of paragraph 19 wherein heating is performed at a temperature between 135° C. and 140° C.

21. The method of paragraphs 14 to 20, wherein the product of step v) or step vi) undergoes searing.

22. The method of paragraph 21, wherein searing is in the presence of a fat.

23. The method of paragraphs 14 to 22, further comprising the step of packaging the food product.

24. The method of paragraphs 14 to 23, further comprising the step of sterilising the food product.

25. The method of paragraph 24, wherein sterilisation by performed by a method selected from the group consisting of: retort sterilisation, microwave sterilisation, radio wave sterilisation, pasteurisation, and ultra-heat treatment (UHT).

26. A liquid mixture comprising a mucilaginous hydrocolloid, a mannan-based hydrocolloid, egg white, insoluble fibre, and water

27. The liquid mixture of paragraphs 26, wherein the mucilaginous hydrocolloid is psyllium.

28. The liquid mixture of paragraphs 26 to 27, wherein the mannan-based hydrocolloid is konjac.

29. The liquid mixture of paragraphs 26 to 28, wherein the insoluble fibre is wheat fibre.

30. The liquid mixture of paragraphs 26 to 29, further comprising a texture enhancer.

31. The liquid mixture of paragraph 30, wherein the texture enhancer is HPMC.

32. The liquid mixture of paragraphs 26 to 31 comprising between 0.1% and 10% by weight of a mucilaginous hydrocolloid, 0.1% and 10% by weight of a mannan-based hydrocolloid, between 5% and 50% by weight of egg white, between 1% and 15% by weight of insoluble fibre, and between 50% and 90% of water, and optionally between 0.1% and 10% by weight of a texture enhancer.

33. The liquid mixture of paragraph 32 comprising between 0.3% and 1% by weight of a mucilaginous hydrocolloid, 0.3% and 1% by weight of a mannan-based hydrocolloid, between 20% and 25% by weight of egg white, between 3% and 10% by weight of insoluble fibre, and between 70% and 75% of water, and optionally between 1% and 2% by weight of a texture enhancer.

34. The liquid mixture of paragraph 33 comprising approximately 0.35% by weight of a mucilaginous hydrocolloid, approximately 0.35% by weight of a mannan-based hydrocolloid, approximately 23% by weight of egg white, approximately 4% by weight of insoluble fibre, and approximately 70% of water, and optionally approximately 1% by weight of a texture enhancer.

35. The liquid mixture of paragraphs 26 to 31 comprising between 0.1% and 10% by weight of psyllium, 0.1% and 10% by weight of konjac, between 5% and 50% by weight of egg white, between 1% and 15% by weight of wheat fibre, and between 50% and 90% of water, and optionally between 0.1% and 10% by weight of HPMC.

36. The liquid mixture of paragraph 35 comprising between 0.3% and 1% by weight of psyllium, 0.3% and 1% by weight of konjac, between 20% and 25% by weight of egg white, between 3% and 10% by weight of wheat fibre, and between 70% and 75% of water, and optionally between 1% and 2% by weight of HPMC.

37. The liquid mixture of paragraph 36 comprising approximately 0.35% by weight of psyllium, approximately 0.35% by weight of konjac, approximately 23% by weight of egg white, approximately 4% by weight of wheat fibre, and approximately 70% of water, and optionally approximately 1% by weight of HPMC.

38. A dehydrated food product comprising a mucilaginous hydrocolloid, a mannan-based hydrocolloid, insoluble fibre, and egg protein.

39. The dehydrated food product of paragraph 38, wherein the mucilaginous hydrocolloid is psyllium.

40. The dehydrated food product of paragraphs 38 to 39, wherein the mannan-based hydrocolloid is konjac.

41. The dehydrated food product of paragraphs 38 to 40, wherein the insoluble fibre is wheat fibre.

42. The dehydrated food product of paragraphs 38 to 41, further comprising a texture enhancer.

43. The dehydrated food product of paragraph 42, wherein the texture enhancer is HPMC.

44. The dehydrated food product of paragraphs 38 to 43, comprising between 1% and 25% by weight of a mucilaginous hydrocolloid, 1% and 25% by weight of a mannan-based hydrocolloid, between 5% and 50% by weight of egg protein, between 30% and 80% by weight of insoluble fibre, and optionally between 5% and 40% by weight of a texture enhancer.

45. The dehydrated food product of paragraph 44, comprising between 3.5% and 10% by weight of a mucilaginous hydrocolloid, 3.5% and 10% by weight of a mannan-based hydrocolloid, between 25% and 35% by weight of egg protein, between 40% and 50% by weight of insoluble fibre, and optionally between 10% and 15% by weight of a texture enhancer.

46. The dehydrated food product of paragraph 45, comprising approximately 3.5% by weight of a mucilaginous hydrocolloid, approximately 3.5% by weight of a mannan-based hydrocolloid, approximately 32% by weight of egg protein, approximately 40% by weight of insoluble fibre, and optionally approximately 12% by weight of a texture enhancer.

47. The dehydrated food product of paragraphs 38 to 43, comprising between 1% and 25% by weight of psyllium, 1% and 25% by weight of konjac, between 5% and 50% by weight of egg protein, between 30% and 80% by weight of wheat fibre, and optionally between 5% and 40% by weight of HPMC.

48. The dehydrated food product of paragraph 47, comprising between 3.5% and 10% by weight of psyllium, 3.5% and 10% by weight of konjac, between 25% and 35% by weight of egg protein, between 40% and 50% by weight of insoluble fibre, and optionally between 10% and 15% by weight of a texture enhancer.

49. The dehydrated food product of paragraph 48, comprising approximately 3.5% by weight of a mucilaginous hydrocolloid, approximately 3.5% by weight of a mannan-based hydrocolloid, approximately 32% by weight of egg protein, approximately 40% by weight of insoluble fibre, and optionally approximately 12% by weight of a texture enhancer.

50. The dehydrated food product of paragraphs 38 to 49, further comprising water.

51. The dehydrated food product of paragraph 45, comprising between 10% and 1% by weight of water.

52. The dehydrated food product of paragraphs 38 to 51, wherein the dehydrated food product is selected form the group consisting of a cracker, a portion of crisps, a portion of noodles, a portion of dried pasta, a portion of dried cereal, a cereal bar, a portion of dried porridge, or a portion of dried muesli.

53. A long shelf life food product comprising a mucilaginous hydrocolloid, a mannan-based hydrocolloid, egg protein, insoluble fibre, and optionally water.

54. A meal item meal item comprising a bakery food product of paragraphs 1 to 13, or a dehydrated food product of paragraphs 38 to 52; and a topping, filling, dressing, sauce, and/or spread.

1. A low fat bakery food product for human consumption comprising a mucilaginous hydrocolloid, a mannan-based hydrocolloid, egg protein, insoluble fibre and water, and wherein the food product comprises less than 3% by weight of fat.

2. The bakery food product of claim 1, wherein the mucilaginous hydrocolloid is psyllium; and/or wherein the mannan-based hydrocolloid is konjac; and/or wherein the insoluble fibre is wheat fibre.

3-4. (canceled)

5. The bakery food product of claim 1, further comprising a texture enhancer, preferably wherein the texture enhancer is hydroxypropylmethylcellulose (HPMC).

6-7. (canceled)

8. The bakery food product of claim 1, wherein the food product comprises between 1% and 5% by weight of a mucilaginous hydrocolloid, 1% and 5% by weight of a mannan-based hydrocolloid, between 12% and 20% by weight of egg protein, between 20% and 25% by weight of insoluble fibre, and between 50% and 60% of water, and optionally between 5% and 10% by weight of a texture enhancer, or preferably comprises approximately 2% by weight of a mucilaginous hydrocolloid, approximately 2% by weight of a mannan-based hydrocolloid, approximately 16% by weight of egg protein, approximately 20% by weight of insoluble fibre, and approximately 52% by weight of water, and optionally approximately 6% by weight of a texture enhancer.

9-10. (canceled)

11. The bakery food product of claim 1, wherein the food product comprises between 1% and 5% by weight of psyllium, 1% and 5% by weight of konjac, between 12% and 20% by weight of egg protein, between 20% and 25% by weight of wheat fibre, and between 50% and 60% of water, and optionally between 5% and 10% by weight of HPMC, or preferably comprises approximately 2% by weight of psyllium, approximately 2% by weight of konjac, approximately 16% by weight of egg protein, approximately 20% by weight of wheat fibre, and approximately 52% of water, and optionally approximately 6% by weight of HPMC.

12. (canceled)

13. The bakery food product according claim 1, wherein the food product is selected from the group consisting of: pizza base, wrap, flatbread, tortilla, bread, cake, pastry, pancake, roll, waffle and biscuit.

14. A method of making a low fat bakery food product for human consumption, wherein the food product comprises less than 3% by weight of fat the method comprising the steps of:
vii) mixing a mucilaginous hydrocolloid, a mannan-based hydrocolloid, insoluble fibre and water, to provide a first mixture;
viii) combining the first mixture with egg white to provide a liquid mixture;
ix) optionally, applying the liquid mixture onto a baking sheet;
x) heating the liquid mixture to remove water and provide a substantially dehydrated food product; and
xi) re-hydrating the dehydrated food product of iv)
xii) optionally forming the food product into shapes.

15. The method of claim 14, wherein the egg white is obtained from egg white powder reconstituted in water, preferably wherein the method comprises whisking egg white prior to combining with the first mixture.

16. The method of claim 14, wherein step i) and step ii) are combined into a single step.

17. (canceled)

18. The method of claim 7, further comprising the step of resting the liquid mixture prior to heating.

19. The method of claim 7, wherein heating is performed at a temperature between 80° C. and 200° C., preferably between 90° C. and 150° C. and more preferably between 135° C. and 140° C.

20. (canceled)

21. The method of claim 7, wherein the product of step v) or step vi) undergoes searing, preferably in the presence of a fat.

22. (canceled)

23. The method of claim 7, further comprising the step of packaging the food product.

24. The method of claim 7, further comprising the step of sterilising the food product, preferably wherein sterilisation by performed by a method selected from the group consisting of: retort sterilisation, microwave sterilisation, radio wave sterilisation, pasteurisation, and ultra-heat treatment (UHT).

25. (canceled)

26. A low fat liquid mixture comprising a mucilaginous hydrocolloid, a mannan-based hydrocolloid, egg white, insoluble fibre, and water; wherein the liquid mixture comprises between 0.1% and 10% by weight of a mucilaginous hydrocolloid, 0.1% and 10% by weight of a mannan-based hydrocolloid, between 5% and 50% by weight of egg white, between 1% and 15% by weight of insoluble fibre, and between 50% and 90% of water, and optionally between 0.1% and 10% by weight of a texture enhancer; and wherein the liquid mixture comprises less than 3% by weight of fat.

27. The liquid mixture of claim 26, wherein the mucilaginous hydrocolloid is psyllium and/or the mannan-based hydrocolloid is konjac and/or wherein the insoluble fibre is wheat fibre.

28-29. (canceled)

30. The liquid mixture of claim 26 to 29, further comprising a texture enhancer, preferably wherein the texture is HPMC.

31. (canceled)

32. The liquid mixture of claim 26, comprising between 0.3% and 1% by weight of a mucilaginous hydrocolloid, 0.3% and 1% by weight of a mannan-based hydrocolloid, between 20% and 25% by weight of egg white, between 3% and 10% by weight of insoluble fibre, and between 70% and 75% of water, and optionally between 1% and 2% by weight of a texture enhancer, or preferably comprising approximately 0.35% by weight of a mucilaginous hydrocolloid, approximately 0.35% by weight of a mannan-based hydrocolloid, approximately 23% by weight of egg white, approximately 4% by weight of insoluble fibre, and approximately 70% of water, and optionally approximately 1% by weight of a texture enhancer.

33-34. (canceled)

35. The liquid mixture of claim 26, comprising between 0.3% and 1% by weight of psyllium, 0.3% and 1% by weight of konjac, between 20% and 25% by weight of egg white, between 3% and 10% by weight of wheat fibre, and between 70% and 75% of water, and optionally between 1% and 2% by weight of HPMC, or preferably comprising approximately 0.35% by weight of psyllium, approximately 0.35% by weight of konjac, approximately 23% by weight of egg white, approximately 4% by weight of wheat fibre, and approximately 70% of water, and optionally approximately 1% by weight of HPMC.

36. (canceled)

37. A low fat dehydrated food product for human consumption comprising a mucilaginous hydrocolloid, a mannan-based hydrocolloid, insoluble fibre, and egg protein; and wherein the dehydrated food product comprises less than 3% by weight of fat.

38. The dehydrated food product of claim 37, wherein the mucilaginous hydrocolloid is psyllium and/or wherein the mannan-based hydrocolloid is konjac and/or wherein the insoluble fibre is wheat fibre.

39-40. (canceled)

41. The dehydrated food product of claim 37, further comprising a texture enhancer, preferably wherein the texture enhancer is HPMC.

42-43. (canceled)

44. The dehydrated food product of claim 37, comprising between 3.5% and 10% by weight of a mucilaginous hydrocolloid, 3.5% and 10% by weight of a mannan-based hydrocolloid, between 25% and 35% by weight of egg protein, between 40% and 50% by weight of insoluble fibre, and optionally between 10% and 15% by weight of a texture enhancer, or preferably comprising approximately 3.5% by weight of a mucilaginous hydrocolloid, approximately 3.5% by weight of a mannan-based hydrocolloid, approximately 32% by weight of egg protein, approximately 40% by weight of insoluble fibre, and optionally approximately 12% by weight of a texture enhancer.

45. (canceled)

46. The dehydrated food product of claim 37, comprising between 1% and 25% by weight of psyllium, 1% and 25% by weight of konjac, between 5% and 50% by weight of egg protein, between 30% and 80% by weight of wheat fibre, and optionally between 5% and 40% by weight of HPMC, or preferably comprising between 3.5% and 10% by weight of psyllium, 3.5% and 10% by weight of konjac, between 25% and 35% by weight of egg protein, between 40% and 50% by weight of insoluble fibre, and optionally between 10% and 15% by weight of a texture enhancer.

47-48. (canceled)

49. The dehydrated food product of claim 37, further comprising water, preferably between 10% and 1% by weight of water.

50. (canceled)

51. The dehydrated food product of claim 37, wherein the dehydrated food product is selected form the group consisting of a cracker, a portion of crisps, a portion of noodles, a portion of dried pasta, a portion of dried cereal, a cereal bar, a portion of dried porridge, or a portion of dried muesli.

52. A long shelf life, low fat food product for human consumption, comprising a mucilaginous hydrocolloid, a mannan-based hydrocolloid, egg protein, insoluble fibre, and optionally water; and wherein the long shelf life food product comprises less than 3% by weight of fat.

53. A meal item meal item comprising a bakery food product comprising a mucilaginous hydrocolloid, a mannan-based hydrocolloid, egg protein, insoluble fibre and water, and wherein the food product comprises less than 3% by weight of fat, or a dehydrated food product comprising a mucilaginous hydrocolloid, a mannan-based hydrocolloid, insoluble fibre, and egg protein; and wherein the dehydrated food product comprises less than 3% by weight of fat; and a topping, filling, dressing, sauce, and/or spread.
